(19) United States
(12) Patent Application Publication
(10) Pub. No.: US 2026/0257310 A1
(43) Pub. Date: Sep. 3, 2026

(54) AUDIO-BASED MODAL ESTIMATION

(71) Applicant: FANUC CORPORATION, Yamanashi (JP)

(72) Inventor: Yen Po Liu, Union City, CA (US)

(21) Appl. No.: 19/068,409

(22) Filed: Mar. 3, 2025

(51) Int. Cl. B23Q 15/12; G01H 3/04

(52) U.S. Cl. CPC B23Q 15/12; G01H 3/04

(57) ABSTRACT

A method for machine tool natural frequency detection which requires no accelerometers or other data acquisition equipment to be attached to the machine tool. A simple hammer or other impact device is used to strike the machine tool, and sound data from the resulting vibration is collected and analyzed. FFT analysis of the sound data reveals natural frequencies of vibration. Data from multiple impacts may be aggregated, and other data processing techniques such as spectral subtraction are employed to reduce the prominence of false peaks in the FFT results and improve the natural frequency prediction accuracy. Workpiece natural frequencies may be predicted in the same manner. The natural frequency information is used to tune machining conditions-in particular, to select a spindle speed resulting in a cutting frequency which has a specified relationship to the identified natural frequencies.

### BACKGROUND

### Field

The present disclosure relates generally to the field of vibration control in a machine tool and, more particularly, to a method for machine tool natural frequency estimation which uses sound data from a tool impact to estimate natural frequencies, where FFTs are performed on the sound data with additional processing, natural frequencies are identified, and the machine tool is operated at a cutting frequency which avoids the identified natural frequencies.

### Discussion of the Related Art

It is known in the art to use computer-controlled devices to perform machining operations, such as drilling and milling, on parts. In some applications, computer numerical controlled (CNC) machines are used which move a tool along three principal directions, with or without changes in the tool's orientation. In other applications, a multi-axis industrial robot is fitted with a machining head, and the robot can move the tool along any arbitrary spatial path while also controlling the tool orientation to any desired value.

Regardless of what type of machine tool or robot is used to perform the machining operation, the quality of the finished workpiece is always important, and conditions which may be detrimental to the workpiece quality or the longevity of the machine tool must be avoided. In particular, it is desirable to minimize vibrations of the machine tool and the workpiece during machining operations.

Some amount of vibration in mechanical systems is virtually impossible to avoid. The goal in machining operations is to minimize the amplitude of vibrations as much as possible via machining parameters which may be controlled. Machine tools are designed with many factors in mind, including rigidity and vibration resistance. However, given a particular design of a machine tool, there is little that can be done to increase the stiffness or damping characteristics.

Instead, it is advantageous to avoid exciting natural frequencies of vibration of the machine tool during the machining operations. This can be done by selecting spindle rotational speeds such that the resultant cutting frequencies are not close to the machine's natural frequencies of vibration. This is only possible, however, if those natural frequencies of vibration are known.

Experimental modal analysis is a technique known in the art for determining a machine tool's natural frequencies of vibration. In experimental modal analysis, an accelerometer is attached to the machine tool, an instrumented impact hammer is used to initiate vibration, and a data acquisition system collects data from the experiment. The experimental modal analysis technique can provide valuable insights into the machine tool's vibration characteristics—including natural frequencies of vibration, vibrational mode shapes and damping information. However, the data acquisition equipment needed for the full modal analysis technique is expensive and requires significant experimental setup time, and there are many situations where the mode shapes and damping information is not necessary.

In view of the circumstances described above, there is a need for an improved and simplified method of determining machine tool natural frequencies which does not require expensive instrumentation and complicated setup procedures.

### SUMMARY

The present disclosure describes a method for machine tool natural frequency detection which requires no accelerometers or other data acquisition equipment to be attached to the machine tool. A simple hammer or other impact device is used to strike the machine tool, and sound data from the resulting vibration is collected and analyzed. FFT analysis of the sound data reveals natural frequencies of vibration. Data from multiple impacts may be aggregated, and other data processing techniques such as spectral subtraction are employed to reduce the prominence of false peaks in the FFT results and improve the natural frequency prediction accuracy. Workpiece natural frequencies may be predicted in the same manner. The natural frequency information is used to tune machining conditions-in particular, to select a spindle speed resulting in a cutting frequency which has a specified relationship to the identified natural frequencies.

Additional features of the presently disclosed systems and methods will become apparent from the following description and appended claims, taken in conjunction with the accompanying drawings.

### BRIEF DESCRIPTION OF THE DRAWINGS

FIG. 1 is an illustration of a workpiece machining operation and the basic concepts involved in machine tool vibration;

FIG. 2 is a schematic illustration of a system including a computer-controlled machine tool performing a machining operation on a workpiece, of a type applicable to the techniques of the present disclosure;

FIG. 3 is a schematic illustration of the machine tool system of FIG. 2 with data collection equipment for audio-based modal estimation, according to an embodiment of the present disclosure;

FIG. 4 is a flowchart diagram of a method for audio-based modal estimation in a machine tool, including audio data acquisition from an impact event, and filtering and analysis of the audio data to determine one or more natural frequencies of vibration, according to embodiments of the present disclosure;

FIGS. 5A and 5B are frequency response graphs of audio data magnitude from various machine tool impact events, illustrating the effects of data processing and aggregation on the frequency response results, according to embodiments of the present disclosure; and

FIG. 6 is a graph comparing frequency response data obtained via experimental modal analysis with frequency response data from the audio-based modal estimation method of the present disclosure.

### DETAILED DESCRIPTION OF THE EMBODIMENTS

The following discussion of the embodiments of the disclosure directed to audio-based modal estimation is merely exemplary in nature, and is in no way intended to limit the disclosed devices and techniques or their applications or uses.

Some amount of vibration in machine tools is unavoidable, considering that the cutting tool repeatedly impacts the workpiece at a high frequency and the stiffness of the machine tool and the workpiece are not infinite. However, because excessive vibration can cause substandard workpiece quality, and even damage to the workpiece and/or the machine tool, it is desirable to minimize vibration as much as possible in machining operations.

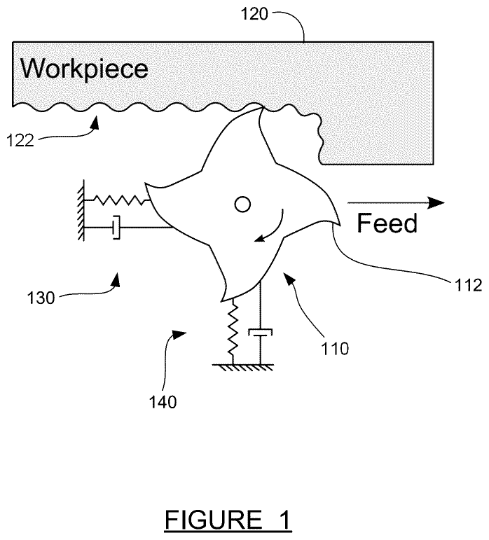

FIG. 1 is an illustration of a workpiece machining operation and the basic concepts involved in machine tool vibration. An end mill 110 is fitted in a spindle of a machine tool (not shown). The end mill 110 (frequently referred to as a cutting tool in the present disclosure) is rotated at a high speed about its central axis by the spindle. The machine tool moves the end mill 110 according to a computer programmed tool path to perform the machining operation on a workpiece 120. Depending on the type of machine tool or robot in which it is fitted, the end mill 110 may be moved in translation only (in three dimensions), or the end mill 110 may be rotated to different orientations in addition to the translational motion. In the example depicted in FIG. 1, the end mill 110 moves in a feed direction as indicated by the annotated arrow, and cuts material from the workpiece 120 as shown. The end mill 110 has four cutting “teeth” or flutes 112. The end mill 110 is merely exemplary, and it is to be understood that the vibration concepts discussed here apply to cutting tools generally, and the modal estimation techniques of the present disclosure are applicable to other milling tools and other types of cutting devices where the vibration phenomenon may be encountered.

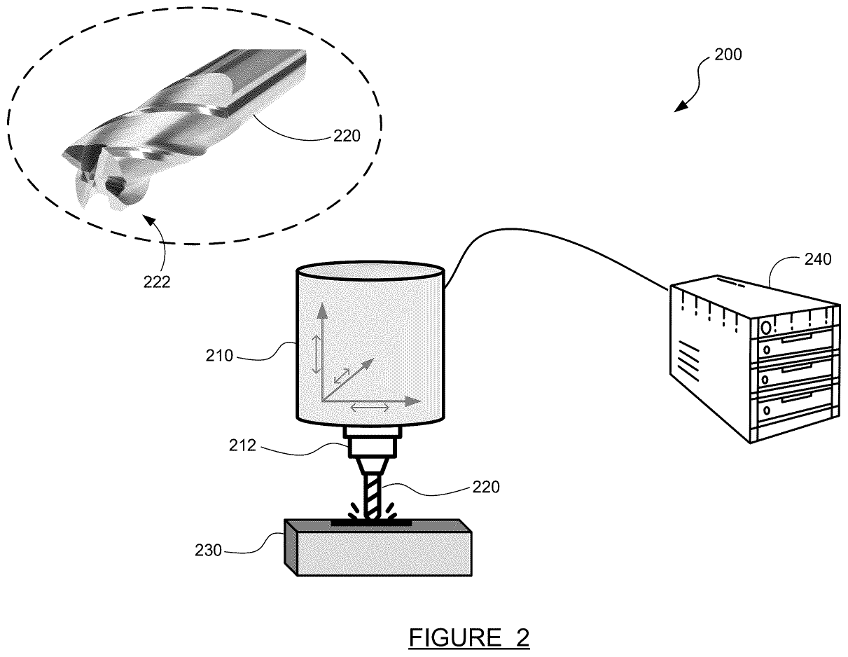

The machine tool which holds the end mill 110 (see FIG. 2 and discussion below) does not have infinite stiffness. In reality, the machine tool system has small amounts of compliance and/or looseness in the machine tool including flexibility of the end mill 110 itself, in the mounting bearings of the spindle, in the overall machine tool mounting and positioning structures, and so forth. Collectively, the compliance and looseness can be characterized as a stiffness and damping 130 in the feed direction (e.g., the machine tool's X axis direction) and a stiffness and damping 140 in a direction perpendicular to the feed direction (e.g., the machine tool's Y axis direction).

As each of the flutes 112 of the end mill 110 strikes the workpiece 120, the impact excites vibration in the machine tool based on the stiffness and damping 130 and the stiffness and damping 140. As a result, after machining, the machined surface of the workpiece 120 does not have a perfectly smooth profile as desired, but rather has a wavy or scalloped shape visible as the vibration marks as indicated at 122. All of the machined surface waviness illustrated in FIG. 1 is exaggerated for visual effect, but the vibration marks 122 on the workpiece surface can in fact be significant enough to negatively impact workpiece quality.

FIG. 2 is a schematic illustration of a system 200 including a computer-controlled machine tool performing a machining operation on a workpiece, of a type applicable to the techniques of the present disclosure. A machine tool 210 rotates a spindle 212 in which is secured a cutting tool 220, such as an end mill, etc. The machine tool 210 causes the cutting tool 220 to perform a machining operation on a workpiece 230. The machine tool 210 is in communication with a controller 240, which is a computing device that provides motion commands and spindle motor speed commands to the machine tool 210. In a typical example, the machine tool 210 would move the rotating cutting tool 220 from a start point along a path which causes material to be cut from the workpiece 230, disengage the cutting tool 220 from the workpiece 230 and move the cutting tool 220 back to a location near the start point, and then make another pass which cuts more material from the workpiece 230.

The cutting tool 220 is shown in more detail in the inset, where the teeth or flutes are visible at a tip 222. Again in this example, the cutting tool 220 includes four teeth or flutes. The number of flutes is significant in relation to vibration conditions, as the number of cutting flute impacts upon the workpiece on each rotation of the cutting tool 220 dictate the cutting frequency. As will be discussed in detail below, the techniques of the present disclosure are applicable to the system 200.

The elements of FIG. 2 are depicted in rather simple fashion, where the machine tool 210 is movable in three principal axes of motion—including “vertically” (parallel to the axis of the cutting tool 220) and in two “horizontal” directions (orthogonal to the axis of the cutting tool 220). It is to be understood that the audio-based modal estimation method of the present disclosure is applicable to any type of machine tool where vibrations may be encountered-including multi-axis machines with tool positioning and orientation capability, and robotically-controlled mills and drills with an articulated robot arm providing complete tool positioning and orientation flexibility.

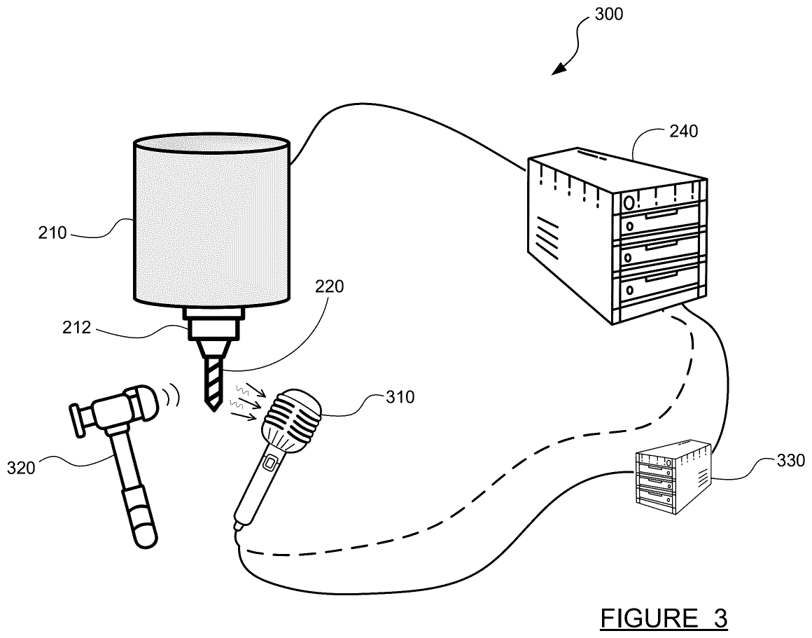

FIG. 3 is a schematic illustration of a system 300 comprised of the machine tool system 200 of FIG. 2 with data collection equipment for audio-based modal estimation, according to an embodiment of the present disclosure. The machine tool 210, the spindle 212, the cutting tool 220 and the controller 240 of FIG. 2 are all shown in FIG. 3. In addition, the system 300 includes a microphone 310, an impact device 320 and a computing device 330.

The basic premise of the presently disclosed audio-based modal estimation method is that, when excited by an impact, the machine tool 210 and cutting tool 220 will respond by vibrating at their natural frequencies. Like a tuning fork or musical instrument, the mechanical vibrations will create sound waves which will have amplitude peaks at the natural frequencies. Even if the sound waves are not clearly audible to a human, the sound waves (audio data) can be collected and analyzed to determine one or more natural frequencies of vibration contained in the data. The details of the technique are discussed below.

The impact device 320 is shown as a hammer with different tips on each end of the head. In the experiments performed to validate the techniques of the present disclosure, a simple and inexpensive hobby hammer was used-with a plastic tip on one end of the head and a metal tip on the other end of the head. Nothing more elaborate than this is needed, and certainly not an instrumented device which is connected to a data acquisition computer as is needed in traditional experimental modal analysis.

The microphone 310 is any suitable audio data collection device capable of collecting and providing audio signal data to a processor such as the computing device 330. In fact, both the microphone 310 and the computing device 330 may be embodied in a mobile device such as a smartphone running an application for collecting and processing the audio signal data as discussed below. In other embodiments, the audio signal data is provided to the computing device 330, which may be a desktop or laptop computer or any other type of computer, and the computing device 330 processes the audio signal data as discussed below. In still other embodiments, the audio signal data is provided directly to the controller 240, and all processing steps are programmed into an algorithm which runs on the controller 240.

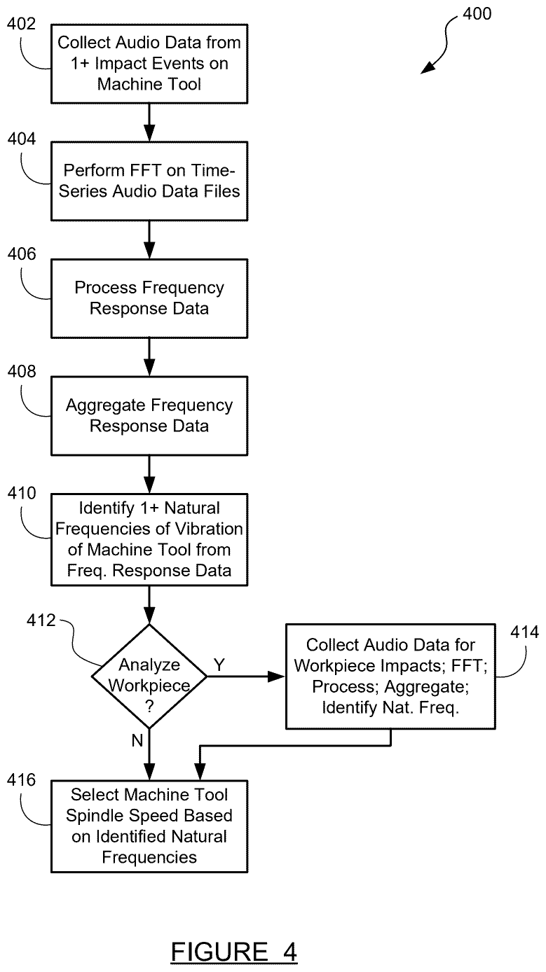

FIG. 4 is a flowchart diagram 400 of a method for audio-based modal estimation in a machine tool, including audio data acquisition from an impact event, and filtering and analysis of the audio data to determine one or more natural frequencies of vibration, according to embodiments of the present disclosure.

At box 402, audio data is collected from one or more impact events on the machine tool. This is as depicted in FIG. 3. The audio data is time-series data indicating the amplitude of the audio signal versus time, for a certain duration of time (e.g., a few seconds) after the impact event. In preferred embodiments, several impact events are performed, with the audio data recorded separately for each impact event. It may also be preferable to perform the impact events with intentionally different impulses-such as some with a metal tip of the impact device 320 and some with a plastic tip of the impact device 320. In one preferred and validated embodiment, five impact events were performed with each of the plastic hammer tip and the metal hammer tip, for a total of ten separate audio files, processed as discussed below.

At box 404, a fast Fourier transform (FFT) is performed on each time-series audio file to create frequency response data for each impact event. The FFT technique is well known in the art, and converts time domain data to the frequency domain, indicating the relative magnitude of the signal at each frequency across a frequency spectrum. The FFT is performed on each audio data file separately, to provide a plurality (e.g., ten, for the embodiment described above) of frequency response files.

At box 406, the frequency response files for each impact event are processed to improve the data quality, including performing a spectral subtraction to eliminate background noise, and calculating a moving average across the frequency spectrum to eliminate artificial spikes.

The spectral subtraction includes recording one or more audio data samples of the background ambient noise environment, where the background noise audio sample(s) may be recorded before, in the middle of, or after the audio files for the machine tool impact events are recorded. The background noise audio samples are then converted to the frequency domain by FFT analysis, and the background noise frequency response is subtracted from each machine tool impact frequency response file, to eliminate spikes in the frequency response which are due to background noise. Background noise spectral subtraction may be necessary in a factory environment, but not necessary if the machine tool impact events are recorded in a quiet laboratory environment.

The moving average calculation may be performed if suitable to smooth the frequency response data and eliminate artificial spikes that may exist at particular frequencies. In one embodiment, the moving average calculation uses a 30 Hertz (Hz) period. Parameters of the moving average calculation may be selected as appropriate to provide best results for a particular application.

The processing steps at the box 406 may be used, or not used, as suitable to obtain the best overall results on an application-specific basis. After the processing at the box 406, the frequency response data for each machine tool impact event is still contained in a separate file, where each frequency response data file has been processed as described above.

At box 408, the frequency response data from all impact events (after processing) is aggregated. For example, if at the box 402 ten audio data files are collected (five each from the plastic hammer tip and the metal hammer tip), then the ten frequency response data files are aggregated into one aggregated frequency response data file at the box 408. The aggregation may be performed by selecting, at each frequency across the frequency spectrum, the median, the average or the minimum of the frequency response values from all impact events after processing. Other aggregation techniques may also be used. Parameters of the frequency response data aggregation may be selected as appropriate to provide best results for a particular application.

Collection of audio data files for multiple impact events and aggregation of the frequency response data for the multiple impact events may provide significantly improved data quality by eliminating fictitious peaks in the frequency response data due to varying quality of impacts. That is, not every impact by the hammer is exactly the same, and the different impulse characteristics create different initial conditions of the vibration, and these differences can be manifested in the frequency response data.

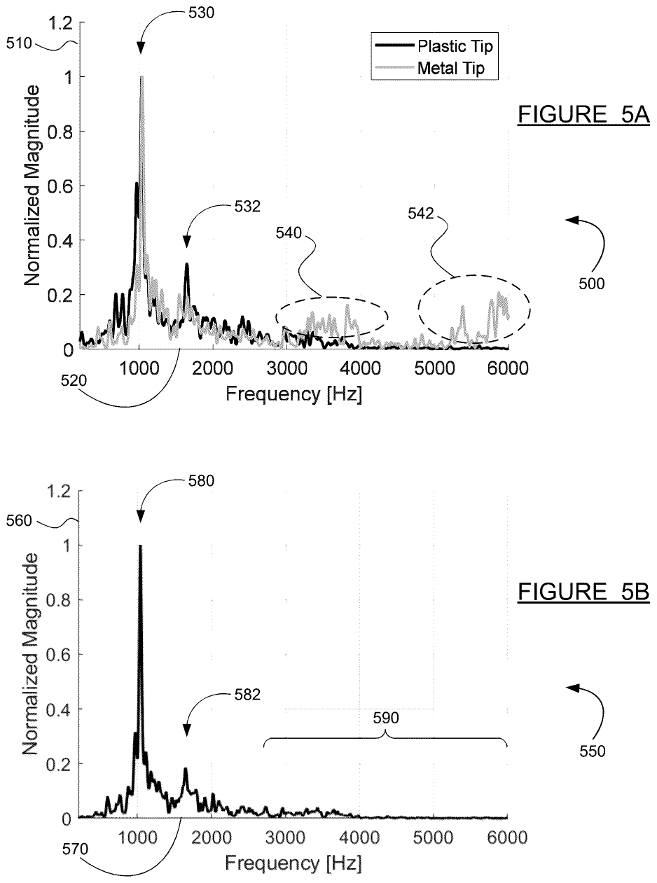

FIGS. 5A and 5B are frequency response graphs of audio data magnitude from various machine tool impact events, illustrating the effects of data processing and aggregation on the frequency response results, according to embodiments of the present disclosure.

FIG. 5A is a graph 500 which plots the audio data magnitude on a vertical axis 510 against frequency on a horizontal axis 520. The graph 500 includes plots for both plastic hammer tip impacts and metal hammer tip impacts, as indicated in the legend. The audio data magnitude for both plastic tip impacts and metal tip impacts includes a large feature (spike) in the response data, as indicated at 530. Based on the magnitude of this spike in relation to the rest of the frequency response data, a machine tool natural frequency is easily identifiable at about 1000 Hz.

Various other smaller magnitude peaks are apparent in the frequency response data on the graph 500. This includes a fairly prominent spike as indicated at 532, and clusters of bumpy peaks as indicated in an ellipse 540 and an ellipse 542. Each of these will be discussed further below.

FIG. 5B is a graph 550 which plots the audio data magnitude on a vertical axis 560 against frequency on a horizontal axis 570, where the graph 550 includes the aggregated frequency response data created at the box 408 of FIG. 4. Specifically, the aggregated frequency response data plotted on the graph 550 was created by taking the minimum magnitude value of any of the frequency response data files at each frequency across the frequency spectrum. For example, if at 2000 Hz, the ten frequency response data files had magnitudes ranging from 0.05 to 0.15, then the aggregated frequency response data would have a value of 0.05 (the minimum of all of the impact events) at that frequency.

Three things are noteworthy in the graph 550. First, the dominant natural frequency of the machine tool is still clearly visible as indicated at 580, at the same frequency as it was found on the graph 500. Second, a smaller peak is also present, as indicated at 582, and this was also present on the graph 500—suggesting that this is a true (albeit less prominent) natural frequency of the machine tool. Third, the higher frequency portions of the frequency spectrum (indicated at 590) are much “quieter” on the graph 550 than on the graph 500. Specifically, the clusters of bumpy peaks contained in the ellipse 540 and the ellipse 542 (in FIG. 5A) are completely gone in FIG. 5B. This demonstrates the effectiveness of the data aggregation step-particularly in eliminating noise in the frequency response results which originated from varying initial condition characteristics of the impact events. That is, fictitious peaks in the frequency response will be reduced or eliminated by aggregation because they are not common in the audio data from all impact events, while true natural frequency peaks will remain in the frequency response results because they are common among all impact events.

Returning to FIG. 4, at box 410, at least one natural frequency of vibration of the machine tool is identified from the aggregate frequency response data. In the actual experimental example shown in FIG. 5B, identification of the predominant natural frequency is obvious—it appears as the one large spike (at 580) in the frequency response data, at about 1050 Hz.

It is also noteworthy from FIGS. 5A and 5B that, even without collecting audio data from multiple impact events and aggregating them in the frequency domain, the primary natural frequency of the machine tool is clearly obvious in all of the data traces. Thus, in some applications, collecting audio data for only one impact event may be sufficient for natural frequency identification.

At decision diamond 412, it is determined whether the audio-based modal estimation technique is to also be used to identify natural frequencies of vibration of the workpiece. In some types of workpieces, such as workpieces with relatively thin cross section, vibration at a workpiece natural frequency may be an issue which needs to be considered. If the answer is yes at the decision diamond 412, then at box 414 the techniques of the present disclosure—depicted in FIG. 3 and detailed in the flowchart diagram of FIG. 4—are applied in the same manner to the workpiece. That is, audio data files from workpiece impact events are recorded, converted to the frequency domain, processed for data quality, and aggregated—and one or more natural frequencies of workpiece vibration are identified. Some workpiece designs may produce more than one natural frequency to be avoided—such as a flat plate workpiece shape which has a bending mode shape at one natural frequency and a twisting/torsional mode shape at another natural frequency.

At box 416, a machine tool spindle speed is selected based on the identified natural frequencies. In one embodiment, the spindle speed is selected such that the cutting frequency avoids the identified natural frequencies in order to minimize vibrations. As mentioned earlier, the cutting frequency is the spindle speed in rpm, divided by 60 to give rotations per second, multiplied by the number of flutes on the cutting tool—in other words the number of cutting tool flute impacts on the workpiece per second. The flute impacts on the workpiece at the cutting frequency produce an excitation which, if corresponding to a machine tool or workpiece natural frequency of vibration, will produce a resonance which dramatically increases vibration amplitude. Under resonance conditions, the quality of the workpiece suffers.

If the workpiece natural frequency estimation is not performed at the box 414, then the one or more natural frequency of the machine tool from the box 410 is used to select the spindle speed at the box 416. If the workpiece natural frequency estimation is performed at the box 414, then the one or more natural frequency of the machine tool from the box 410 and one or more natural frequency of the workpiece are used to select the spindle speed at the box 416. An example of this is discussed below. Criteria may be defined for selecting the machine tool spindle speed to avoid the identified natural frequencies—such as choosing a spindle speed with a corresponding cutting frequency which is separated from the identified natural frequencies (of the machine tool and the workpiece if applicable) by a certain number of Hz, or by a certain percentage, for example. Harmonics of the cutting frequency (e.g., 2×) and their relationship to the identified natural frequencies may also be considered in the criteria for selecting the spindle speed.

As mentioned above, one way to use the natural frequency information is to select the spindle speed such that the cutting frequency and its significant harmonics avoid the identified natural frequencies of the machine tool and the workpiece, in order to minimize vibrations. Another way to use the natural frequency information is to select the spindle speed such that the cutting frequency or one of its significant harmonics matches one of the identified natural frequencies, in order to counteract chatter. For cases where no other practical way to avoid chatter is available, causing resonant vibrations intentionally (by selecting a spindle speed where the cutting frequency matches a machine tool or workpiece natural frequency) is a technique which can be used to eliminate chatter. The motivation for doing so is that resonant vibration is less severe than chatter. Therefore, at the box 416, the spindle speed my be selected based on this logic and criteria.

The audio-based modal estimation technique discussed above has been demonstrated to be very efficient and accurate in predicting machine tool and workpiece natural frequencies of vibration. This has been validated both by comparison to traditional experimental modal analysis, and by vibration measurements at various spindle speeds in actual machining operations.

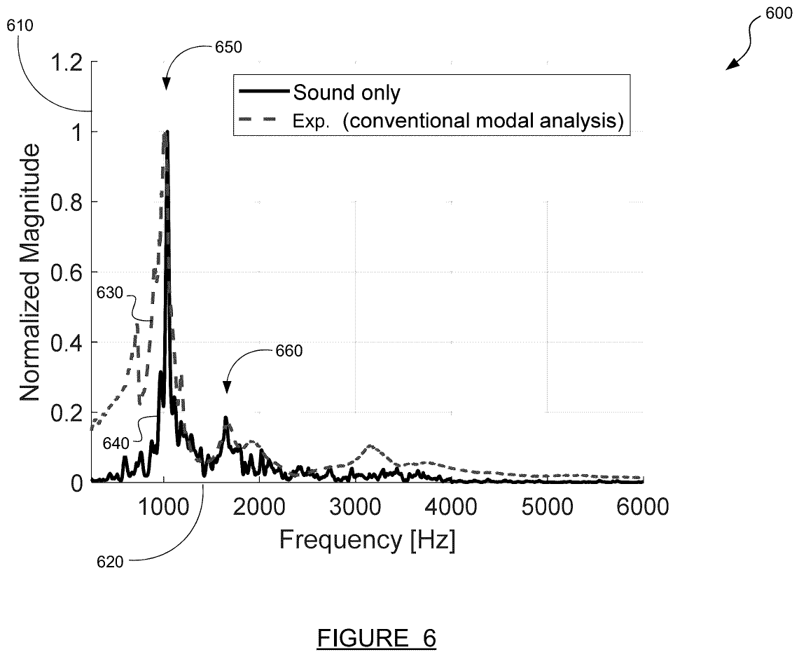

FIG. 6 is a graph 600 comparing frequency response data obtained via experimental modal analysis with frequency response data from the audio-based modal estimation method of the present disclosure. The graph 600 plots the normalized response magnitude on a vertical axis 610 against frequency on a horizontal axis 620. The graph 600 includes plots for data obtained via experimental modal analysis in a dashed-line trace 630 and data obtained via the audio-based modal estimation method of FIG. 4 in a solid-line trace 640, as indicated in the legend.

It is immediately apparent in viewing the graph 600 that the general characteristics of the frequency response results are the same from both experimental modal analysis and audio-based modal estimation methods, and that both methods identify the same dominant natural frequency of vibration at the same frequency. This underscores the basic premise of the presently disclosed techniques—that the simple, fast, inexpensive audio-based modal estimation technique may be used to identify natural frequencies of vibration in a highly accurate and effective manner.

FIG. 6 depicts the results from one experiment, representing one particular machine tool configuration. Other experiments were also conducted, on other machine tool configurations and on different types of workpieces, to validate the accuracy of the disclosed audio-based modal estimation techniques. In all cases, the dominant natural frequencies identified by experimental modal analysis were also identified, within a small single digit error percentage, by the disclosed audio-based modal estimation techniques. In the case of plate-shaped workpieces, this included identifying the first two natural frequencies of the workpiece (one having a bending mode shape and another having a torsional mode shape).

In order to further demonstrate the effectiveness of the disclosed audio-based modal estimation techniques and the importance of considering machine tool and workpiece natural frequencies when selecting spindle speed, machining tests were performed at multiple spindle speeds and vibrations were recorded using an accelerometer.

In one of these experiments, the machine tool was determined via audio-based modal estimation (and validated by experimental modal analysis) to have a dominant natural frequency of 960 Hz, while a workpiece was determined to have significant natural frequencies at 594 Hz (bending) and 1688 Hz (torsion). Tests were run at three different machine tool spindle speeds—spanning the range of identified natural frequencies. The hypothesis to be validated is that, in order to minimize vibration amplitude, a spindle speed should be selected such that the cutting frequency (and its harmonics) avoids the machine tool and workpiece natural frequencies.

Specifically, spindle speeds of 7000, 9000 and 18000 rpm were tested—which correspond (for a cutting tool with four flutes) with cutting frequencies of 467, 600 and 1200 Hz, respectively. In these tests, the machining operation using a 9000 rpm spindle speed (600 Hz cutting frequency) resulted in the highest vibration amplitude (acceleration and displacement). This is to be expected because the 600 Hz cutting frequency is very close to the 594 Hz natural frequency of vibration of the workpiece.

The machining operation using a 7000 rpm spindle speed (467 Hz cutting frequency) resulted in a vibration amplitude which was significantly less than the vibration at the 9000 rpm spindle speed. The machining operation using an 18000 rpm spindle speed (1200 Hz cutting frequency) resulted in a vibration amplitude which was significantly less than the vibration at the 7000 rpm spindle speed, and very significantly less than the vibration at the 9000 rpm spindle speed.

Using the audio-based modal estimation techniques of the present disclosure, natural frequencies of vibration can quickly and easily be identified for both the machine tool and the workpiece, and an appropriate spindle speed can then be selected which avoids those natural frequencies. In the example described above, a spindle speed is readily selected which results in the lowest vibration amplitude and also performs the machining operation the fastest, which is best on both counts. The natural frequency identification is done without the expensive and time-consuming proposition of traditional experimental model analysis.

Throughout the preceding discussion, various computers and controllers are described and implied. It is to be understood that the software applications and modules of these computers and controllers are executed on one or more electronic computing devices having a processor and a memory module. In particular, this includes the machine controller 240 of FIGS. 2 and 3 which was discussed earlier, along with the computing device 330 of FIG. 3. Specifically, the processor in the controller 240 and/or the computing device 330 is configured to perform the audio-based modal estimation as described above, including the method steps of FIG. 4, and the calculations and other techniques described above. In addition, the controller 240 controls of the machine tool itself including setting the spindle speed to the value determined after evaluation of machine tool and workpiece natural frequencies.

While a number of exemplary aspects and embodiments of the method for audio-based modal analysis have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An audio-based method for natural frequency identification of a machine tool, said method comprising:
collecting audio data from at least one impact event on the machine tool;
performing a fast Fourier transform (FFT) on the audio data, using a computing device having a processor and memory, to produce frequency response data for each of the impact events;
aggregating the frequency response data for all of the impact events into an aggregated frequency response;
identifying at least one natural frequency of vibration of the machine tool from the aggregated frequency response; and
selecting a machine tool spindle speed, for a machining operation on a workpiece, such that a corresponding cutting frequency is related to the at least one natural frequency of vibration of the machine tool according to predefined criteria.

2. The method according to claim 1 further comprising processing the frequency response data for each of the impact events before aggregating, including performing a spectral subtraction of background noise and calculating a moving average across a frequency spectrum.

3. The method according to claim 2 wherein performing the spectral subtraction of background noise includes collecting background audio data of an ambient environment around the machine tool, performing an FFT on the background audio data to produce background frequency response data, and subtracting the background frequency response data from the frequency response data for each of the impact events across the frequency spectrum.

4. The method according to claim 1 further comprising identifying at least one natural frequency of vibration of the workpiece, using the audio-based method for natural frequency identification, wherein the machine tool spindle speed is selected such that the cutting frequency is separated from the at least one natural frequency of vibration of the machine tool and the at least one natural frequency of vibration of the workpiece according to the predefined criteria.

5. The method according to claim 1 wherein the corresponding cutting frequency is the machine tool spindle speed in rotations per second multiplied by a number of cutting flutes on a cutting tool in a spindle of the machine tool.

6. The method according to claim 5 wherein the predefined criteria include selecting the machine tool spindle speed to minimize vibration such that the corresponding cutting frequency and select cutting frequency harmonics are separated from the at least one natural frequency of vibration by at least a designated number of cycles per second, or by at least a specified percentage.

7. The method according to claim 5 wherein the predefined criteria include selecting the machine tool spindle speed to counteract chatter such that one of the corresponding cutting frequency or select cutting frequency harmonics matches the at least one natural frequency of vibration.

8. The method according to claim 1 wherein collecting audio data from at least one impact event includes collecting audio data from a first plurality of impact events where a first impact device is used to impact the machine tool and a second plurality of impact events where a second impact device is used to impact the machine tool.

9. The method according to claim 8 wherein aggregating the frequency response data for all of the impact events includes creating the aggregated frequency response by selecting, at each frequency across the frequency spectrum, a mean, a median or a minimum of frequency response values for all of the impact events.

10. The method according to claim 1 wherein the machine tool is a computer numerically controlled (CNC) machine or the machine tool is a multi-axis articulated robot.

11. An audio-based method for natural frequency identification of a machining operation, said method comprising:
collecting audio data from a plurality of impact events on a machine tool;
performing a fast Fourier transform (FFT) on the audio data, using a computing device having a processor and memory, to produce frequency response data for each of the impact events;
processing the frequency response data for each of the impact events, including performing a spectral subtraction of background noise and calculating a moving average across a frequency spectrum;
aggregating the frequency response data for all of the impact events into an aggregated frequency response, including creating the aggregated frequency response by selecting, at each frequency across the frequency spectrum, a mean, a median or a minimum of frequency response values for all of the impact events;
identifying at least one natural frequency of vibration of the machine tool from the aggregated frequency response;
identifying at least one natural frequency of vibration of a workpiece, using the audio-based method for natural frequency identification; and
selecting a machine tool spindle speed for the machining operation such that a corresponding cutting frequency and select cutting frequency harmonics are related to the at least one natural frequency of vibration of the machine tool and the at least one natural frequency of vibration of the workpiece according to predefined criteria.

12. The method according to claim 11 wherein the corresponding cutting frequency is the machine tool spindle speed in rotations per second multiplied by a number of cutting flutes on a cutting tool in a spindle of the machine tool, and where the predefined criteria include selecting the machine tool spindle speed to minimize vibration such that the corresponding cutting frequency and the select cutting frequency harmonics are separated from the natural frequencies of vibration of the machine tool and the workpiece by at least a designated number of cycles per second or percentage, or selecting the machine tool spindle speed to counteract chatter such that the corresponding cutting frequency or one of the select cutting frequency harmonics matches one of the natural frequencies of vibration of the machine tool and the workpiece.

13. A machine tool natural frequency identification system, said system comprising:
a machine tool configured for performing an operation on a workpiece;
a microphone placed proximal the machine tool; and
a computing device in communication with the microphone, said computing device being configured to identify natural frequencies by performing steps including;
collecting audio data from at least one impact event on the machine tool;
performing a fast Fourier transform (FFT) on the audio data, to produce frequency response data for each of the impact events;
aggregating the frequency response data for all of the impact events into an aggregated frequency response; and
identifying at least one natural frequency of vibration of the machine tool from the aggregated frequency response.

14. The system according to claim 13 further comprising selecting a machine tool spindle speed, for the operation on the workpiece, such that a corresponding cutting frequency is related to the at least one natural frequency of vibration of the machine tool according to predefined criteria.

15. The system according to claim 14 wherein the corresponding cutting frequency is the machine tool spindle speed in rotations per second multiplied by a number of cutting flutes on a cutting tool in a spindle of the machine tool, and where the predefined criteria include selecting the machine tool spindle speed to minimize vibration such that the corresponding cutting frequency and select cutting frequency harmonics are separated from the at least one natural frequency of vibration of the machine tool by at least a designated number of cycles per second or percentage, or selecting the machine tool spindle speed to counteract chatter such that the corresponding cutting frequency or one of the select cutting frequency harmonics matches the at least one natural frequency of vibration of the machine tool.

16. The system according to claim 14 further comprising identifying at least one natural frequency of vibration of the workpiece, including collecting workpiece audio data from at least one workpiece impact event, performing an FFT on the workpiece audio data and aggregating workpiece frequency response data for all workpiece impact events, wherein the machine tool spindle speed is selected such that the cutting frequency is related to the at least one natural frequency of vibration of the machine tool and the at least one natural frequency of vibration of the workpiece according to the predefined criteria.

17. The system according to claim 13 further comprising processing the frequency response data for each of the impact events before aggregating, including performing a spectral subtraction of background noise and calculating a moving average across a frequency spectrum.

18. The system according to claim 13 wherein collecting audio data from at least one impact event includes collecting audio data from a first plurality of impact events where a first impact device is used to impact the machine tool and a second plurality of impact events where a second impact device is used to impact the machine tool.

19. The system according to claim 13 wherein aggregating the frequency response data for all of the impact events includes creating the aggregated frequency response by selecting, at each frequency across the frequency spectrum, a mean, a median or a minimum of frequency response values for all of the impact events.

20. The system according to claim 13 wherein the machine tool is a computer numerically controlled (CNC) machine or the machine tool is a multi-axis articulated robot.
